(19) United States
(12) Patent Application Publication
(10) Pub. No.: US 2025/0101208 A1
(43) Pub. Date: Mar. 27, 2025

(54) RUBBER FORMULATIONS COMPRISING A STATISTICAL COPOLYMER COMPRISING VINYLBENZOCYCLOBUTANE

(71) Applicants: Bridgestone Corporation, Chuo-ku (JP); Bridgestone Americas Tire Operations, LLC, Nashville, TN (US)

(72) Inventors: Terrence Eugene Hogan, Uniontown, OH (US); Walter Anthony Salamant, Akron, OH (US)

(73) Assignees: Bridgestone Corporation, Chuo-ku, TK (JP); Bridgestone Americas Tire Operations, LLC, Nashville, TN (US)

(21) Appl. No.: 18/897,669

(22) Filed: Sep. 26, 2024

Related U.S. Application Data
(60) Provisional application No. 63/585,707, filed on Sep. 27, 2023.

(51) Int. Cl. C08L 9/06; B60C 1/00; C08J 3/24; C08K 3/04; C08K 3/36

(52) U.S. Cl. CPC C08L 9/06; B60C 1/0016; C08J 3/247; C08K 3/04; C08K 3/36; C08L 2207/322; C08L 2310/00; C08L 2312/02

(57) ABSTRACT

Embodiments of the present disclosure are directed to rubber formulations, wherein the formulations include a statistical copolymer. The statistical copolymer includes a polymerized, crosslinkable e reaction product derived from a conjugated diene monomer and vinylbenzocyclobutane. The rubber formulation is substantially free of traditional rubber curatives.

### CROSS-REFERENCE TO RELATED APPLICATIONS

The present specification claims the benefit of U.S. Provisional Application Ser. No. 63/585,707 filed Sep. 27, 2023 and entitled “Rubber Formulations Comprising a Statistical Copolymer Comprising Vinylbenzocyclobutane,” the entirety of which is incorporated by reference herein.

### TECHNICAL FIELD

Embodiments of the present disclosure are generally related to statistical copolymers comprising vinylbenzocyclobutane, and are specifically related to rubber formulations comprising statistical copolymers comprising vinylbenzocyclobutane.

### BACKGROUND

Rubber formulations comprising synthetic and/or natural rubbers are commonly used in tire applications, for example, tire tread. However, curing the rubber formulation may require the addition of curing agents, such as zinc oxide or sulfur. These curing agents may be expensive and a decrease in their use may improve the overall sustainability of rubber formulations. Further, the addition of these curing agents may require further processing of the rubber formulations, which may increase the cost of producing the rubber formulation.

Accordingly, a continual need exists for rubber formulations that do not require the addition of curing agents, thereby reducing costs and improving sustainability.

### SUMMARY

Embodiments of the present disclosure are directed to rubber formulations comprising a statistical copolymer that comprises vinylbenzocyclobutane, hereinafter referred to as “VBCB,” which may be cured without the use of curatives used in sulfur/zinc-based crosslinking processes or peroxide-based crosslinking processes. Specifically, the use of a statistical copolymer comprising vinylbenzocyclobutane allows for curing to occur without the use of these curatives because vinylbenzocyclobutane may react when heated to form crosslinks with other vinylbenzocyclobutane monomers or with C—C double bonds present in the statistical copolymer.

According to one embodiment, a rubber formulation is provided. The rubber formulation includes a statistical copolymer. The statistical copolymer includes a polymerized, crosslinkable reaction product derived from a conjugated diene monomer and vinylbenzocyclobutane. The rubber formulation is substantially free of curative used in sulfur/zinc-based crosslinking processes or peroxide-based crosslinking processes.

Additional features and advantages of the embodiments described herein will be set forth in the detailed description which follows, and in part will be readily apparent to those skilled in the art from that description or recognized by practicing the embodiments described herein, including the detailed description which follows, and the claims.

### DRAWINGS

FIG. 1 is a plot of time (x-axis; in minutes) versus torque (y-axis; in deciNewton meters) of an example statistical copolymer with and without the presence of Cu(BF₄)₂, according to one or more embodiments described herein.

### DETAILED DESCRIPTION

Embodiments of the present disclosure are directed to rubber formulations. The rubber formulations may comprise a statistical copolymer. The statistical copolymer may be a polymerized, crosslinkable reaction product derived from a conjugated diene monomer and vinylbenzocyclobutane. The rubber formulation may be substantially free of curatives used in sulfur/zinc-based crosslinking processes or peroxide-based crosslinking processes.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “statistical copolymer,” as described herein, refers to a copolymer in which individual monomer units are arranged along the polymer chain following a statistical distribution. Statistical copolymers are copolymers in which the sequential distribution of the monomeric units obeys known statistical laws; for example, the monomer sequence distribution may follow Markovian statistics of zeroth (Bernoullian), first, second, or higher order. Kinetically, the elementary processes leading to the formation of a statistical sequence of monomeric units do not necessarily proceed with equal a priori probability. These processes can lead to various types of sequence distribution comprising those in which the arrangement of monomeric units tends toward alternation, tends toward clustering of like units, or exhibits no ordering tendency at all. In simple binary copolymerization, the nature of this sequence distribution can be indicated by the numerical values of a function either of the reactivity ratios or of the related run number.

The term “substantially free,” as described herein with respect to traditional rubber curatives, refers to an amount of traditional rubber curatives that is insufficient to facilitate curing as measured according to ASTM D2084-19a, such as, for example less than or equal to 1.0 wt. %, or 0.9 wt. %, or 0.8 wt. %, or 0.7 wt. %, or 0.6 wt. % or 0.5 wt. %.

The term “phr,” as described herein, refers to parts by weight of the identified component per 100 parts rubber.

Number average molecular weight Mₙ, weight average molecular weight Mw, and peak molecular weight Mₚ, as described herein, are determined by gel permeation chromatography, as elaborated on in the Examples.

“MH” refers to “maximum torque” and measures the value of shear modulus or rigidity of the fully vulcanized formulation, as measured according to ASTM D5289.

“ML” refers to “minimum torque” and measures value of the vulcanization characteristic (viscosity) of the unvulcanized formulation, as measured according to ASTM D5289.

“T 90” refers to the time in which the torque is increased to ML+90 (MH-ML)/100 dNm, reflecting optimum vulcanization of the formulation, as measured according to ASTM D5289.

“T 50” refers to the time in which the torque is increased to ML+50 (MH-ML)/100 dnM, as measured according to ASTM D5289.

Glass transition temperature T_{g}, as described herein, is measured by differential scanning calorimetry.

The viscoelastic properties loss tangent tan δ at 0° C., 30° C., and 60° C. and storage modulus G′ at −20° C. and at −30° C., described herein were measured by a temperature sweep test conducted with an Advanced Rheometric Expansion System (ARES) from TA Instruments

The tensile mechanical properties modulus at 50% strain M50, modulus at 100% strain M100, modulus at 200% strain M200, stress at break Tb, and maximum strain Eb, described herein are determined in accordance with ASTM D412, as elaborated on in the Examples.

The viscoelastic properties loss tangent tan δ (5%), loss tangent tan δ (10%), and change in storage modulus G′ (0.25-14%), described herein were measured by a strain sweep test conducted with an Advanced Rheometric Expansion System from TA Instruments.

As discussed hereinabove, typical rubber curing processes utilize expensive curing agents such as zinc oxide and sulfur. A decrease in the use of these curing agents may also affect the overall the sustainability of the rubber formulations. Furthermore, the curing agents must typically be added in a separate final stage of mixing at a relatively lower temperature to prevent scorching of the rubber. This additional stage of mixing may increase the total processing time of the rubber formulations.

Disclosed herein are rubber formulations, which mitigate the aforementioned problems. Specifically, the rubber formulations disclosed herein comprise a statistical copolymer of a conjugated diene monomer and vinylbenzocyclobutane, which results in a rubber formulation that does not require the use of zinc oxide or sulfur to cure the rubber formulation. The presence of vinylbenzocyclobutane, as part of a statistical copolymer, allows crosslinking to occur between polymer chains and the statistical distribution of the vinylbenzocyclobutane along the polymer chain to promote an even distribution of crosslinks with higher crosslink density. This crosslinking allows the rubber formulations to cure without the use of curatives, such as zinc oxide and sulfur, thereby reducing costs and improving sustainability of the rubber formulations.

### Statistical Copolymer

The statistical copolymers disclosed herein may generally be described as comprising a conjugated diene and vinylbenzocyclobutane

The statistical copolymer comprises vinylbenzocyclobutane. Without being bound by theory, it is believed that VBCB monomer units within a polymer chain may form crosslinks with other VBCB monomer units on other polymer chains as well as form crosslinks with the unsaturation in the polymeric backbone of other polymer chains. These crosslinks may provide the statistical copolymer with desired mechanical properties once the statistical copolymer is cured. Further, it is believed that the presence of vinylbenzocyclobutane may allow the rubber formulation to cure without the use of curatives, such as zinc oxide and sulfur. In embodiments, the statistical copolymer may be the polymerized, crosslinkable reaction product derived from a conjugated diene monomer and VBCB.

In embodiments, the statistical copolymer may comprise VBCB in an amount, based on the total weight of the statistical copolymer, greater than or equal to about 0.02 wt. %, greater than or equal to about 0.1 wt. %, greater than or equal to about 0.25 wt. %, greater than or equal to about 0.5 wt. %, greater than or equal to about 0.75 wt. %, or even greater than or equal to about 1.0 wt. %. In embodiments the statistical copolymer may comprise VBCB in an amount, based on a total weight of the statistical copolymer, less than or equal to about 2.0 wt. %, less than or equal to about 1.75 wt. %, less than or equal to about 1.5 wt. %, or even less than or equal to about 1.25 wt. %. In embodiments, the statistical copolymer may comprise VBCB in an amount, based on a total weight of the statistical copolymer, from about 0.02 wt. % to about 2.0 wt. %, from about 0.02 wt. % to about 1.75 wt. %, from about 0.02 wt. % to about 1.5 wt. %, from about 0.02 wt. % to about 1.25 wt. %, from about 0.1 wt. % to about 2.0 wt. %, from about 0.1 wt. % to about 1.75 wt. %, from about 0.1 wt. % to about 1.5 wt. %, from about 0.1 wt. % to about 1.25 wt. %, from about 0.25 wt. % to about 2.0 wt. %, from about 0.25 wt. % to about 1.75 wt. %, from about 0.25 wt. % to about 1.5 wt. %, from about 0.25 wt. % to about 1.25 wt. %, from about 0.5 wt. % to about 2.0 wt. %, from about 0.5 wt. % to about 1.75 wt. %, from about 0.5 wt. % to about 1.5 wt. %, from about 0.5 wt. % to about 1.25 wt. %, from about 0.75 wt. % to about 2.0 wt. %, from about 0.75 wt. % to about 1.75 wt. %, from about 0.75 wt. % to about 1.5 wt. %, from about 0.75 wt. % to about 1.25 wt. %, from about 1.0 wt. % to about 2.0 wt. %, from about 1.0 wt. % to about 1.75 wt. %, from about 1.0 wt. % to about 1.5 wt. %, or even from about 1.0 wt. % to about 1.25 wt. %, or any and all sub-ranges formed from any of these endpoints. Without being bound by theory it is believed that a statistical copolymer that comprises less than 0.02 wt. % of VBCB may not have the desired crosslink density and distribution after curing. It is also believed that VBCB in an amount greater than 2.0 wt. %, may negatively impact the tensile properties of the cured rubber formulation, such as, for example, the elongation of the rubber formulation.

In embodiments, the polymer may comprise from 1 to 15 VBCB monomer units per polymer chain. In embodiments, the polymer may comprise greater than or equal to 1, greater than or equal to 2, greater than or equal to 3, greater than or equal to 4, greater than or equal to 5, greater than or equal to 6, or even greater than or equal to 7 VBCB monomer units per polymer chain. In embodiments, the polymer may comprise less than or equal to 15, less than or equal to 14, less than or equal to 13, less than or equal to 12, less than or equal to 11, less than or equal to 10, or even less than or equal to 9 VBCB monomer units per polymer chain. In embodiments, the polymer may comprise from 1 to 15, from 1 to 14, from 1 to 13, from 1 to 12, from 1 to 11, from 1 to 10, from 1 to 9, from 2 to 15, from 2 to 14, from 2 to 13, from 2 to 12, from 2 to 11, from 2 to 10, from 2 to 9, from 3 to 15, from 3 to 14, from 3 to 13, from 3 to 12, from 3 to 11, from 3 to 10, from 3 to 9, from 4 to 15, from 4 to 14, from 4 to 13, from 4 to 12, from 4 to 11, from 4 to 10, from 4 to 9, from 5 to 15, from 5 to 14, from 5 to 13, from 5 to 12, from 5 to 11, from 5 to 10, from 5 to 9, from 6 to 15, from 6 to 14, from 6 to 13, from 6 to 12, from 6 to 11, from 6 to 10, from 6 to 9, from 7 to 15, from 7 to 14, from 7 to 13, from 7 to 12, from 7 to 11, from 7 to 10, or even from 7 to 9, or any and all sub-ranges formed from any of these endpoints, VBCB monomer units per chain.

In embodiments, the polymer may have at least 1 VBCB monomer unit at an end of the polymer chain. In embodiments, the polymer may have at least 2, at least 3, or even at least 4 VBCB monomer units at the end of the polymer chain. In embodiments, the polymer may have from 1 to 4, from 1 to 3, from 1 to 2, from 2 to 4, from 2 to 3, from 3 to 4, or any and all sub-ranges formed from any of these endpoints, VBCB monomer units at the end of the polymer chain.

In embodiments greater than or equal to about 50% of polymer chains in the polymer may have from 0.5 to 3 VBCB monomer units on the end of the polymer. In embodiments, greater than or equal to about 55%, greater than or equal to about 60%, greater than or equal to about 65%, greater than or equal to about 70%, greater than or equal to about 75%, greater than or equal to about 80%, greater than or equal to about 85%, or even greater than or equal to about 90% of polymer chains may have from 0.5 to 3 VBCB monomer units on the end of the polymer chain. In embodiments, greater than or equal to about 50% of polymer chains may have from 0.5 to 3, from 0.5 to 2.5, from 0.5 to 2, from 0.5 to 1.5, from 0.5 to 1 from 1 to 3, from 1 to 2.5, from 1 to 2, from 1 to 1.5, from 1.5 to 3, from 1.5 to 2.5, from 1.5 to 2, from 2 to 3, from 2 to 2.5, from 2.5 to 3, or any and all sub-ranges formed from any of these endpoints, VBCB monomer units on the end of the polymer chain. In such embodiments, the remainder of VBCB monomer units may be statistically distributed throughout the polymer chain.

The statistical copolymers disclosed herein comprise a conjugated diene. Without being bound by theory, it is believed that the VBCB monomer units may form crosslinks with the carbon-carbon double bonds of the conjugated diene monomer units. This may allow for increased crosslink density, as the VBCB monomer units may be able to form more crosslinks when compared to polymers that do not comprise conjugated diene monomer units.

In embodiments the conjugated diene monomer may be selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, 1,3-cyclooctadiene, and combinations thereof. In embodiments, the conjugated diene monomer may be 1,3-butadiene.

In embodiments, the statistical copolymer may comprise from about 50 wt. % to about 99 wt. % of the conjugated diene monomer, based on the total weight of the statistical copolymer. In embodiments, the statistical copolymer may comprise the conjugated diene monomer in an amount, based on the total weight of the statistical copolymer, greater than or equal to about 50 wt. %, greater than or equal to about 55 wt. %, greater than or equal to about 60 wt. %, or even greater than or equal to about 65 wt. %. In embodiments, the statistical copolymer may comprise the conjugated diene monomer in an amount, based on the total weight of the statistical copolymer, less than or equal to about 99 wt. %, less than or equal to about 95 wt. %, less than or equal to about 90 wt. %, less than or equal to about 85 wt. %, or even less than or equal to about 80 wt. %. In embodiments, the statistical copolymer may comprise the conjugated diene monomer in an amount, based on the total weight of the statistical copolymer, from about 50 wt. % to about 99 wt. %, from about 50 wt. % to about 95 wt. %, from about 50 wt. % to about 90 wt. %, from about 50 wt. % to about 85 wt. %, from about 50 wt. % to about 80 wt. %, from about 55 wt. % to about 99 wt. %, from about 55 wt. % to about 90 wt. %, from about 55 wt. % to about 85 wt. %, from about 55 wt. % to about 80 wt. %, from about 60 wt. % to about 99 wt. %, from about 60 wt. % to about 95 wt. %, from about 60 wt. % to about 90 wt. %, from about 60 wt. % to about 85 wt. %, from about 60 wt. % to about 80 wt. %, from about 65 wt. % to about 99 wt. %, from about 65 wt. % to about 95 wt. %, from about 65 wt. % to about 90 wt. %, from about 65 wt. % to about 85 wt. %, or even from about 65 wt. % to about 80 wt. %, or any and all sub-ranges formed from any of these endpoints.

In embodiments, the statistical copolymer may be a polymerized, crosslinkable reaction product derived from a conjugated diene monomer, a vinyl aromatic monomer, and VBCB. Without being bound by theory, it is believed that the presence of a vinyl aromatic monomer may increase the glass transition of the polymer, when compared to polymer without a vinyl aromatic monomer. Increasing the glass transition temperature of a polymer may improve the wet and dry traction of a tire made using a rubber formulation that comprises that polymer.

In embodiments, the vinyl aromatic monomer may be selected from the group consisting of styrene, alpha-methyl styrene, p-methylstyrene, o-methylstyrene, p-butyl styrene, vinylnapthalene, p-tertbutylstyrene, 4-vinylbiphenyl, 2-vinylnapthalene, 9-vinylanthracene, vinyl catechol, and combinations thereof. In embodiments, the vinyl aromatic monomer may be styrene.

In embodiments, the statistical copolymer may comprise from about 5 wt. % to about 50 wt. % of vinyl aromatic monomer, based on the total weight of the statistical copolymer. In embodiments, the statistical copolymer may comprise the vinyl aromatic monomer in an amount, based on the total weight of the statistical copolymer, greater than or equal to about 5 wt. %, greater than or equal to about 10 wt. %, greater than or equal to about 15 wt. %, or even greater than or equal to about 20 wt. %. In embodiments the statistical copolymer may comprise the vinyl aromatic monomer in an amount, based on the total weight of the statistical copolymer, less than or equal to about 50 wt. %, less than or equal to about 45 wt. %, less than or equal to about 40 wt. %, less than or equal to about 35 wt. %, or even less than or equal to about 30 wt. %. In embodiments, the statistical copolymer may comprise the vinyl aromatic monomer in an amount, based on the total weight of the statistical copolymer, from about 5 wt. % to about 50 wt. %, from about 5 wt. % to about 45 wt. %, from about 5 wt. % to about 40 wt. %, from about 5 wt. % to about 35 wt. %, from about 5 wt. % to about 30 wt. %, from about 10 wt. % to about 50 wt. %, from about 10 wt. % to about 45 wt. %, from about 10 wt. % to about 40 wt. %, from about 10 wt. % to about 35 wt. %, from about 10 wt. % to about 30 wt. %, from about 15 wt. % to about 50 wt. %, from about 15 wt. % to about 45 wt. %, from about 15 wt. % to about 40 wt. %, from about 15 wt. % to about 35 wt. %, from about 15 wt. % to about 30 wt. %, from about 20 wt. % to about 50 wt. %, from about 20 wt. % to about 45 wt. %, from about 20 wt. % to about 40 wt. %, from about 20 wt. % to about 35 wt. %, or even from about 20 wt. % to about 30 wt. %, or any and all sub-ranges formed from any of these endpoints.

In embodiments, the statistical copolymer may have a weight average molecular weight of incorporated conjugated diene monomers, incorporated vinyl aromatic monomers, or combinations thereof between VBCB monomer units of from about 10,000 g/mol to about 50,000 g/mol. In embodiments, the statistical copolymer may have a weight average molecular weight of conjugated diene monomers, incorporated vinyl aromatic monomers, or combinations thereof between VBCB monomer units of greater than or equal to about 10,000 g/mol, greater than or equal to about 15,000 g/mol, greater than or equal to about 20,000 g/mol, or even greater than or equal to about 25,000 g/mol. In embodiments, the statistical copolymer may have a weight average molecular weight of conjugated diene monomers, incorporated vinyl aromatic monomers, or combinations thereof between VBCB monomer units of less than or equal to about 50,000 g/mol, less than or equal to about 45,000 g/mol, less than or equal to about 40,000 g/mol, or even less than or equal to about 35,000 g/mol. In embodiments, the statistical copolymer may have a weight average molecular weight of incorporated conjugated diene monomers, incorporated vinyl aromatic monomers, or combinations thereof between VBCB monomer units of from about 10,000 g/mol to about 50,000 g/mol, from about 10,000 g/mol to about 45,000 g/mol, from about 10,000 g/mol to about 40,000 g/mol, from about 10,000 g/mol to about 35,000 g/mol, from about 15,000 g/mol to about 50,000 g/mol, from about 15,000 g/mol to about 45,000 g/mol, from about 15,000 g/mol to about 40,000 g/mol, from about 15,000 g/mol to about 35,000 g/mol, from about 20,000 g/mol to about 50,000 g/mol, from about 20,000 g/mol to about 45,000 g/mol, from about 20,000 g/mol to about 40,000 g/mol, from about 20,000 g/mol to about 35,000 g/mol, from about 25,000 g/mol to about 50,000 g/mol, from about 25,000 g/mol to about 45,000 g/mol, from about 25,000 g/mol to about 40,000 g/mol, or even from about 25,000 g/mol to about 35,000 g/mol, or any and all sub-ranges formed from any of these endpoints. Without being bound by theory, it is believed that a weight average molecular weight of incorporated conjugated diene monomers, incorporated vinyl aromatic monomers, or combinations thereof between VBCB monomer units of less than about 10,000 g/mol may cause a rubber formulation to cure too tightly and may negatively impact the elongation of the cured rubber. It is also believed that a weight average molecular weight of incorporated conjugated diene monomers, incorporated vinyl aromatic monomers, or combinations thereof between VBCB monomer units of greater than about 50,000 g/mol may cause a rubber formulation to lack the desired crosslink density.

In embodiments, the statistical copolymer may have a weight average molecular weight Mw of from about 1.0×10⁵ g/mol to about 2.0×10⁶ g/mol. In embodiments, the statistical copolymer may have a weight average molecular weight Mw of greater than or equal to about 1.0×10⁵ g/mol, greater than or equal to about 2.5×10⁵ g/mol, greater than or equal to about 5.0×10⁵ g/mol, or even greater than or equal to about 7.5×10⁵ g/mol. In embodiments, the statistical copolymer may have a weight average molecular weight Mw of less than or equal to about 2.0×10⁶ g/mol, less than or equal to about 1.75×10⁶ g/mol, less than or equal to about 1.5×10⁶ g/mol, or even less than or equal to about 1.25×10⁶ g/mol. In embodiments the statistical copolymer may have a weight average molecular weight Mw of from about 1.0×10⁵ g/mol to about 2.0×10⁶ g/mol, from about 1.0×10⁵ g/mol to about 1.75×10⁶ g/mol, from about 1.0×10⁵ g/mol to about 1.5×10⁶ g/mol, from about 1.0×10⁵ g/mol to about 1.25×10⁶ g/mol, from about 2.5×10⁵ g/mol to about 2.0×10⁶ g/mol, from about 2.5×10⁶ g/mol to about 1.75×10⁶ g/mol, from about 2.5×10⁵ g/mol to about 1.5×10⁶ g/mol, from about 2.5×10⁵ g/mol to about 1.25×10⁶ g/mol, from about 5.0×10⁵ g/mol to about 2.0×10⁶ g/mol, from about 5.0×10⁵ g/mol to about 1.75×10⁶ g/mol, from about 5.0×10⁵ g/mol to about 1.5×10⁶ g/mol, from about 5.0×10⁵ g/mol to about 1.25×10⁶ g/mol, from about 7.5×10⁵ g/mol to about 2.0×10⁶ g/mol, from about 7.5×10⁵ g/mol to about 1.75×10⁶ g/mol, from about 7.5×10⁵ g/mol to about 1.5×10⁶ g/mol, or even from about 7.5×10⁵ g/mol to about 1.25×10⁶ g/mol, or any and all sub-ranges formed from any of these endpoints. Without being bound by theory, it is believed that a statistical copolymer having a weight average molecular weight of less than about 1.0×10⁵ g/mol may be more difficult to process than a statistical copolymer having a weight average molecular weight of from about 1.0×10⁵ g/mol to about 2.0×10⁶ g/mol because of an increased risk of cold flow. It is also believed that a statistical copolymer having a weight average molecular weight of greater than about 2.0×10⁶ may be more difficult to process than a statistical copolymer having a weight average molecular weight of from about 1.0×10⁵ g/mol to about 2.0×10⁶ g/mol because of the increased viscosity of the statistical copolymer.

In embodiments, the copolymer may have a number average molecular weight Mₙ of from about 1.0×10⁵ g/mol to about 2.0×10⁶ g/mol. In embodiments, the copolymer may have a number average molecular weight Mₙ of greater than or equal to about 1.0×10⁵ g/mol, greater than or equal to about 2.5×10⁵ g/mol, greater than or equal to about 5.0×10⁵ g/mol, or even greater than or equal to about 7.5×10⁵ g/mol. In embodiments, the copolymer may have a number average molecular weight Mₙ of less than or equal to about 2.0×10⁶ g/mol, less than or equal to about 1.75×10⁶ g/mol, less than or equal to about 1.5×10⁶ g/mol, or even less than or equal to about 1.25×10⁶ g/mol. In embodiments the copolymer may have a number average molecular weight Mₙ of from about 1.0×10⁵ g/mol to about 2.0×10⁶ g/mol, from about 1.0×10⁵ g/mol to about 1.75×10⁶ g/mol, from about 1.0×10⁵ g/mol to about 1.5×10⁶ g/mol, from about 1.0×10⁵ g/mol to about 1.25×10⁶ g/mol, from about 2.5×10⁵ g/mol to about 2.0×10⁶ g/mol, from about 2.5×10⁶ g/mol to about 1.75×10⁶ g/mol, from about 2.5×10⁵ g/mol to about 1.5×10⁶ g/mol, from about 2.5×10⁵ g/mol to about 1.25×10⁶ g/mol, from about 5.0×10⁵ g/mol to about 2.0×10⁶ g/mol, from about 5.0×10⁵ g/mol to about 1.75×10⁶ g/mol, from about 5.0×10⁵ g/mol to about 1.5×10⁶ g/mol, from about 5.0×10⁵ g/mol to about 1.25×10⁶ g/mol, from about 7.5×10⁵ g/mol to about 2.0×10⁶ g/mol, from about 7.5×10⁵ g/mol to about 1.75×10⁶ g/mol, from about 7.5×10⁵ g/mol to about 1.5×10⁶ g/mol, or even from about 7.5×10⁵ g/mol to about 1.25×10⁶ g/mol, or any and all sub-ranges formed from any of these endpoints.

In embodiments, the copolymer may have a peak molecular weight Mₚ of from about 1.0×10⁵ g/mol to about 2.0×10⁶ g/mol. In embodiments, the copolymer may have a peak molecular weight Mₚ of greater than or equal to about 1.0×10⁵ g/mol, greater than or equal to about 2.5×10⁵ g/mol, greater than or equal to about 5.0×10⁵ g/mol, or even greater than or equal to about 7.5×10⁵ g/mol. In embodiments, the copolymer may have a peak molecular weight Mₚ of less than or equal to about 2.0×10⁶ g/mol, less than or equal to about 1.75×10⁶ g/mol, less than or equal to about 1.5×10⁶ g/mol, or even less than or equal to about 1.25×10⁶ g/mol. In embodiments the copolymer may have a peak molecular weight Mₚ of from about 1.0×10⁵ g/mol to about 2.0×10⁶ g/mol, from about 1.0×10⁵ g/mol to about 1.75×10⁶ g/mol, from about 1.0×10⁵ g/mol to about 1.5×10⁶ g/mol, from about 1.0×10⁵ g/mol to about 1.25×10⁶ g/mol, from about 2.5×10⁵ g/mol to about 2.0×10⁶ g/mol, from about 2.5×10⁶ g/mol to about 1.75×10⁶ g/mol, from about 2.5×10⁵ g/mol to about 1.5×10⁶ g/mol, from about 2.5×10⁵ g/mol to about 1.25×10⁶ g/mol, from about 5.0×10⁵ g/mol to about 2.0×10⁶ g/mol, from about 5.0×10⁵ g/mol to about 1.75×10⁶ g/mol, from about 5.0×10⁵ g/mol to about 1.5×10⁶ g/mol, from about 5.0×10⁵ g/mol to about 1.25×10⁶ g/mol, from about 7.5×10⁵ g/mol to about 2.0×10⁶ g/mol, from about 7.5×10⁵ g/mol to about 1.75×10⁶ g/mol, from about 7.5×10⁵ g/mol to about 1.5×10⁶ g/mol, or even from about 7.5×10⁵ g/mol to about 1.25×10⁶ g/mol, or any and all sub-ranges formed from any of these endpoints.

In embodiments, the statistical copolymer may have a polydispersity (PDI) of less than or equal to 1.5, less than or equal to 1.4, less than or equal to 1.3, less than or equal to 1.2, or even less than or equal to 1.1.

In embodiments, the statistical copolymer may have a glass transition temperature T_{g} of from about −100° C. to about −20° C. In embodiments, the statistical copolymer may have a glass transition temperature T_{g} of greater than or equal to −100° C., greater than or equal to −90° C., greater than or equal to −80° C., or even greater than or equal to −70° C. In embodiments, the statistical copolymer may have a glass transition temperature T_{g} of less than or equal to −20° C., less than or equal to −30° C., less than or equal to −40° C., or even less than or equal to −50° C. In embodiments the statistical copolymer may have a glass transition temperature T_{g} of from about −100° C. to about −20° C., from about −100° C. to about −30° C., from about −100° C. to about −40° C., from about-100 to about −50° C., from about −90° C. to about −20° C., from about −90° C. to about −30° C., from about −90° C. to about −40° C., from about −90° C. to about −50° C., from about −80° C. to about −20° C., from about −80° C. to about −30° C., from about −80° C. to about −40° C., from about −80° C. to about −50° C., from about −70° C. to about −20° C., from about −70° C. to about −30° C., from about −70° C. to about −40° C., or even from about −70° C. to about −50° C., or any and all sub-ranges formed from any of these endpoints. Without being bound by theory, it is believed that a glass transition temperature of greater than about −20° C. may negatively impact the snow and rolling resistance performance of a tire tread that incorporates the statistical copolymer.

In embodiments, a rubber component of the rubber formulation may comprise the statistical copolymer in an amount, based on the total weight of the rubber component, greater than or equal to about 20 phr, greater than or equal to about 30 phr, greater than or equal to about 40 phr, or even greater than or equal to about 50 phr. In embodiments, the rubber components may comprise the statistical copolymer in an amount, based on the total weight of the rubber component, less than or equal to about 100 phr, less than or equal to about 90 phr, less than or equal to about 80 phr, or even less than or equal to about 70 phr. In embodiments, the rubber component may comprise the statistical copolymer in an amount, based on the total weight of the rubber component, from about 20 phr to about 100 phr, from about 20 phr to about 90 phr, from about 20 phr to about 80 phr, from about 20 phr to about 70 phr, from about 30 phr to about 100 phr, from about 30 phr to about 90 phr, from about 30 phr to about 80 phr, from about 30 phr to about 70 phr, from about 40 phr to about 100 phr, from about 40 phr to about 90 phr, from about 40 phr to about 80 phr, from about 40 phr to about 70 phr, from about 50 phr to about 100 phr, from about 50 phr to about 90 phr, from about 50 phr to about 80 phr, or even from about 50 phr to about 70 phr, or any and all sub-ranges formed from any of these endpoints.

The practice of the present invention also advantageously provides a method whereby a tire component is produced from a cured rubber matrix that has a relatively high content of sustainable constituents, which include recycled materials, naturally-derived materials, and/or materials synthesized from bio-synthesized feedstock or bio-based materials. For example, the tires or tire components of the present invention can include greater than 40 wt. %, in other embodiments greater than 50 wt. %, and in other embodiments greater than 60 wt. % sustainable materials. In these or other embodiments, the tire or tire components include from about 40 to about 90 wt. %, in other embodiments from about 45 to about 85 wt. %, and in other embodiments from about 50 to about 80 wt. % sustainable material. The cured rubber matrix with filler dispersed therein may include greater than 40 wt. %, or 50 wt. %, or 60 wt. %, or 70 wt. %, or 80 wt. %, or 90 wt. %, or 99 wt. % of a statistical copolymer.

### Fillers

The rubber compositions of the present invention include fillers such as organic and inorganic fillers. Examples of organic fillers include carbon black and starch. Examples of inorganic fillers include silica, aluminum hydroxide, magnesium hydroxide, mica, talc (hydrated magnesium silicate), and clays (hydrated aluminum silicates). In certain embodiments, a mixture of different fillers may be advantageously employed.

The amount of total filler employed in the rubber compositions can be up to about 150 parts by weight per 100 parts by weight of rubber (phr), with about 30 to about 125 phr, or about 40 to about 110 phr being typical. In certain embodiments the total filler content is greater than about 100 phr. In other embodiments, the total filler content is from about 50 to about 100 phr, and in in further embodiments from about 55 to about 95 phr.

Conventional carbon black can be used, which is generally known in the art. In one or more embodiments, carbon blacks include furnace blacks, channel blacks, and lamp blacks. More specific examples of carbon blacks include super abrasion furnace blacks, intermediate super abrasion furnace blacks, high abrasion furnace blacks, fast extrusion furnace blacks, fine furnace blacks, semi-reinforcing furnace blacks, medium processing channel blacks, hard processing channel blacks, conducting channel blacks, and acetylene blacks.

In particular embodiments, the carbon blacks may have a surface area (EMSA) of at least 20 m²/g and in other embodiments at least 35 m²/g; surface area values can be determined by ASTM D-1765 using the cetyltrimethylammonium bromide (CTAB) technique. The carbon blacks may be in a pelletized form or an unpelletized flocculent form. The preferred form of carbon black may depend upon the type of mixing equipment used to mix the rubber compound.

In one or more embodiments, carbon black can be sourced from a recycled material. Such recycled material can include reclaimed or recycled vulcanized rubber, whereby the vulcanized rubber is typically reclaimed from manufactured articles such as a pneumatic tire, an industrial conveyor belt, a power transmission belt, and a rubber hose. The recycled carbon black may be obtained by a pyrolysis process or other methods known for obtaining recycled carbon black. In an aspect, a recycled carbon black can be formed from incomplete combustion of recycled rubber feedstock or rubber articles. In another aspect, the recycled carbon black can be formed from the incomplete combustion of feedstock including oil resulting from the tire pyrolysis process. The carbon blacks utilized in the preparation of the vulcanizable elastomeric compositions can be in pelletized form or an unpelletized flocculent mass.

The amount of carbon black employed in the rubber compositions can be up to about 75 parts by weight per 100 parts by weight of rubber (phr), with about 5 to about 60 phr, or about 10 to about 55 phr being typical.

The rubber composition can further include filler in the form of one or more recycled rubbers in a particulate form. Recycled particulate rubber is typically broken down and reclaimed (or recycled) by any of a plurality of processes, which can include physical breakdown, grinding, chemical breakdown, devulcanization, cryogenic grinding, a combination thereof, etc. The term “recycled particulate rubber” can relate to both vulcanized and devulcanized rubber, where devulcanized recycle or recycled rubber (reclaim rubber) relates to rubber which has been vulcanized, ground into particulates and may have further undergone substantial or partial devulcanization. In an example, the recycled particulate rubber used in the rubber composition is essentially free of recycled rubber resulting from devulcanization. In a situation where the vulcanized rubber contains wire or textile fiber reinforcement, such wire or fiber reinforcement can be removed by any suitable process such as magnetic separation, air aspiration and/or air flotation step. In certain embodiments, the “recycled particulate rubber” comprises cured, i.e., vulcanized (crosslinked) rubber that has been ground or pulverized into particulate matter having a mean average particle size as discussed below.

Commercially available silicas which may be used for the current invention include Hi-Sil™ 215, Hi-Sil™ 233, and Hi-Sil™ 190 (PPG Industries, Inc.; Pittsburgh, Pa.). Other suppliers of commercially available silica include Grace Davison (Baltimore, Md.), Degussa Corp. (Parsippany, N.J.), Rhodia Silica Systems (Cranbury, N.J.), and J.M. Huber Corp. (Edison, N.J.). Such silicas may be considered as sustainable materials. Other sustainable silicas include those derived from rice husk ash.

In one or more embodiments, silicas may be characterized by their surface areas, which give a measure of their reinforcing character. The Brunauer, Emmet and Teller (“BET”) method (described in J. Am. Chem. Soc., 1939, vol. 60, 2 p. 309-319) is a recognized method for determining the surface area. The BET surface area of silica is generally less than 450 m²/g. Useful ranges of surface area include from about 32 to about 400 m²/g, about 100 to about 250 m²/g, about 130 to about 240 m²/g, and about 170 to about 220 m²/g. In certain embodiments, the silica may have a BET surface area of 190 to about 280 m²/g. The pH's of the silicas are generally from about 5 to about 7 or slightly over 7, or in other embodiments from about 5.5 to about 6.8.

In one or more embodiments, where silica is employed as a filler (alone or in combination with other fillers), a coupling agent and/or a shielding agent may be added to the rubber compositions during mixing in order to enhance the interaction of silica with the elastomers. Useful coupling agents and shielding agents are disclosed in U.S. Pat. Nos. 3,842,111; 3,873,489; 3,978,103; 3,997,581; 4,002,594; 5,580,919; 5,583,245; 5,663,396; 5,674,932; 5,684,171; 5,684,172; 5,696,197; 6,608,145; 6,667,362; 6,579,949; 6,590,017; 6,525,118; 6,342,552; and 6,683,135; which are incorporated herein by reference.

The amount of silica employed in the rubber compositions can be from about 1 to about 150 phr or in other embodiments from about 5 to about 130 phr. The useful upper range is limited by the high viscosity imparted by silicas. In certain embodiments, the silica employed in the rubber composition is derived from rice husk ash only, and in other embodiments the rubber compositions do not include silica from non-rice husk ash derived processes. When silica is used together with carbon black, the amount of the silica or carbon black individually can be as low as about 1 phr. Generally, the amounts of coupling agents and shielding agents range from about 4 wt. % to about 20 wt. % based on the weight of silica used. In one or more embodiments, where carbon black and silica are employed in combination as a filler, the weight ratio or silica to total filler may be from about 5 wt. % to about 99 wt. % of the total filler, in other embodiments from about 10 wt. % to about 90 wt. % of the total filler, or in yet other embodiments from about 50 wt. % to about 85 wt. % of the total filler. In certain embodiments the silica and carbon black fillers employed in the rubber composition are selected from the group consisting of sustainable pyrolysis carbon black and/or rice husk ash derived silica.

A multitude of rubber curing agents (also called vulcanizing agents) may be employed, including sulfur or peroxide-based curing systems. Curing agents are described in Kirk-Othmer, ENCYCLOPEDIA OF CHEMICAL TECHNOLOGY, Vol. 20, pgs. 365-468, (3rd Ed. 1982), particularly Vulcanization Agents and Auxiliary Materials, pgs. 390-402, and A. Y. Coran, Vulcanization, ENCYCLOPEDIA OF POLYMER SCIENCE AND ENGINEERING, (2nd Ed. 1989), which are incorporated herein by reference. Vulcanizing agents may be used alone or in combination.

Other ingredients that are typically employed in rubber compounding may also be added to the rubber compositions. These include accelerators, accelerator activators, oils, plasticizer, waxes, scorch inhibiting agents, processing aids, zinc oxide, tackifying resins, reinforcing resins, fatty acids such as stearic acid, peptizers, and antidegradants such as antioxidants and antiozonants.

With regard to oils, sustainable oils, which include plant-based oils and bio-based oils, may be used. Plant-based oils may include plant-based triglycerides. Exemplary oils include, without limitation, palm oil, soybean oil (also referred to herein as soy oil), rapeseed oil, sunflower seed, peanut oil, cottonseed oil, oil produced from palm kernel, coconut oil, olive oil, corn oil, grape seed oil, hemp oil, linseed oil, rice oil, safflower oil, sesame oil, mustard oil, flax oil. Other examples include nut-derived oils such oils obtained from beech nuts, cashews, mongongo nuts, macadamia nuts, pine nuts, hazelnuts, chestnuts, acorns, almonds, pecans, pistachios, walnuts, or brazil nuts. As the skilled person will appreciate, these oils can be produced by any suitable process such as mechanical extraction (e.g., using an oil mill), chemical extraction (e.g., using a solvent, such as hexane or carbon dioxide), pressure extraction, distillation, leaching, maceration, purification, refining, hydrogenation, sparging, etc.

Bio-based oils, also referred to as bio-oils, can include oils produced by a recombinant cell. For example, bio-oils produced by recombinant cells can be produced using a select strain of algal cells that are fed with a supply of sugars (e.g., sucrose) and then allowed to ferment and produce a bio-oil with a selected profile; after sufficient growth or fermentation has taken place, the bio-oil is isolated from the cells and collected.

Generally, the rubber compositions of this invention can include from about 1 to about 70 parts by weight, or in other embodiments from about 5 to about 50 parts weight total oil per 100 parts by weight rubber. The amount of sustainable oil, relative to the total weight of oil included, may be from about 1 wt. % to about 99 wt. %, or in other embodiment from about 20 wt. % to about 80 wt. %.

With regard to waxes, the rubber compositions can include one or more sustainable waxes, which include natural waxes. A natural wax, or one with no petroleum as its raw material, can include carnauba wax, candelilla wax (e.g., extracted from candelilla flowers), rice wax (e.g., separated from rice bran oil) and Japan wax (e.g., extracted from Japanese wax tree).

Generally, the rubber compositions of this invention include from about 1 to about 20 parts by weight, or in other embodiments from about 2 to about 15 parts by weight total wax per 100 parts by weight rubber. The amount of sustainable wax, relative to the total weight of wax included, may be from about 1 wt. % to about 99 wt. %, or in other embodiment from about 20 wt. % to about 80 wt. % of the total wax. In certain embodiments, the rubber composition includes sustainable waxes only.

In embodiments, the rubber formulation may comprise silane as a coupling agent. In embodiments, the rubber formulation may comprise from about 1 phr to about 20 phr of silane. In embodiments, the amount of silane in the rubber formulation may be greater than or equal to about 1 phr, greater than or equal to about 2 phr, greater than or equal to about 4 phr, greater than or equal to about 6 phr, or even greater than or equal to about 8 phr. In embodiments, the amount of silane in the rubber formulation may be less than or equal to about 20 phr, less than or equal to about 18 phr, less than or equal to about 16 phr, less than or equal to about 14 phr, or even less than or equal to about 12 phr. In embodiments, the amount of silane in the rubber formulation may be from about 1 phr to about 20 phr, from about 1 phr to about 18 phr, from about 1 phr to about 16 phr, from about 1 phr to about 14 phr, from about 1 phr to about 12 phr, from about 2 phr to about 20 phr, from about 2 phr to about 18 phr, from about 2 phr to about 16 phr, from about 2 phr to about 14 phr, from about 2 phr to about 12 phr, from about 4 phr to about 20 phr, from about 4 phr to about 18 phr, from about 4 phr to about 16 phr, from about 4 phr to about 14 phr, from about 4 phr to about 12 phr, from about 6 phr to about 20 phr, from about 6 phr to about 18 phr, from about 6 phr to about 16 phr, from about 6 phr to about 14 phr, from about 6 phr to about 12 phr, from about 8 phr to about 20 phr, from about 8 phr to about 18 phr, from about 8 phr to about 16 phr, from about 8 phr to about 14 phr, or even from about 4 phr to about 12 phr, or any and all sub-ranges formed from any of these endpoints.

In embodiments, the rubber formulation may comprise additional rubbers that are not a polymerized reaction product derived from vinylbenzocyclobutane. These additional rubbers may also include other synthetic rubber, such as synthetic rubber that derives from petroleum-based raw materials, synthetic rubber that derives from other sustainable processes, as well as natural rubber. As the skilled person understands, natural rubber is synthesized by and obtained from plant life. For example, natural rubber can be obtained from Hevea rubber trees, guayule shrub, gopher plant, mariola, rabbitbrush, milkweeds, goldenrods, pale Indian plantain, rubber vine, Russian dandelions, mountain mint, American germander, and tall bellflower.

Other synthetic polymers, if used, can include, without limitation, synthetic polyisoprene, polybutadiene, polyisobutylene-co-isoprene, neoprene, poly(ethylene-co-propylene), poly(styrene-co-butadiene), poly(styrene-co-isoprene), poly(styrene-co-isoprene-co-butadiene), poly(isoprene-co-butadiene), poly(ethylene-co-propylene-co-diene), polysulfide rubber, acrylic rubber, urethane rubber, silicone rubber, epichlorohydrin rubber, and mixtures thereof. These elastomers can have a myriad of macromolecular structures including linear, branched, and star-shaped structures.

Generally, the rubber compositions of this invention include from about 5 to about 45 wt. %, in other embodiments from about 15 to about 40 wt. %, and in other embodiments from about 20 to about 35 wt. % elastomer, based on the total weight of the tire component.

In embodiments, the rubber formulation may be substantially free of curatives used in sulfur/zinc-based crosslinking processes or peroxide-based crosslinking processes. In embodiments, the rubber formulation may be substantially free of zinc oxide, sulfur, diphenylguanidine, fatty acids, benzothiazoles, sulfenamides, sulfenimides, thiurams, dithiocarbamates, or combinations thereof. In one or more embodiments, the total weight percent of curatives in the rubber formulation may be less than about 1.0 wt. %, less than about 0.9 wt. %, less than about 0.8 wt. %, less than about 0.7 wt. %, less than about 0.6 wt. %, less than about 0.5 wt. %, less than about 0.3 wt. %, or even less than about 0.1 wt. %.

In one or more embodiments, the rubber formulation may comprise at least one copper containing compound. Such copper compounds comprise acetates, acetylacetonates, aluminates, bicarbonates, borates, bromates, carbonates, chlorites, cyanides, diethylcitrates, halides, hexafluoroacetylacetonates, hexafluorophosphates, hexafluorosilicates, dihydrogen phosphates, hydrogen carbonates, hydrogen sulphates, hydrogen sulphides, hydrogen sulphites, hydroxides, hypochlorites, iodates, nitrates, nitrites, oxalates, oxides, perfluorophthalocyanines, peroxides, phosphates, phthalocyanines, pyrophosphates, silicates, sulphamates, sulphates, sulphides, sulphites, tartrates, tetrafluoroborates, thiocyanates, thiolates, thiosulphates, tosylates and triflates of these metals. Preferred compounds in this context include CuOCOCH₃, Cu(OCOCH₃)₂, Cu(OCOCH₃)₂xH₂O, Cu(C₅H₇O₂)₂, CuBr, CuBr₂, CuCO₃, CuCO₃, Cu(OH)₂, CuCl, CuCl₂, CuCl₂xH₂O, Cu [CH₃ (CH₂)₃CH(C₂H₅) CO₂]₂, CuF₂, CuF₂xH₂O, Cu(HCO₂)₂, Cu(HCO₂)₂xH₂O, Cu(OH)₂, Cu₂ (OH) PO₄, CuI, CuFe₂O₄, Cu(NO₃)₂, Cu(NO₃)₂xH₂O, Cu₂O, CuO, Cu(C₃₂H₁₆N₈), Cu₂P₂O₇xH₂O, CuSO₄, CuSO₄xH₂O, CuS, Cu [O₂CCH(OH) CH(OH) CO₂]xH₂O, Cu(BF₄)₂, Cu(BF₄) xH₂O, Cu(SCN), Cu(BF₄)₂, Cu(PF₆)₂, or CuF₂. Especially preferred compounds include Cu(BF₄)₂, Cu(PF₆)₂, or CuF₂. Without being bound by theory, it is believed these copper compounds may reduce the temperature required to cure the rubber formulation by reducing the energy required for the VBCB in the statistical copolymer to form crosslinks.

### Method of Making

In embodiments, the rubber formulations of the present disclosure may be made by a method comprising polymerizing conjugated diene monomer and VBCB monomer, and optionally vinyl aromatic monomer in the presence of an anionic initiator to produce polymer chains with a living end and a randomizing component to produce a statistical copolymer. The polymerization may produce a statistical copolymer as described hereinabove. The rubber formulation may then be heated to a temperature of from 170° C. to 240° C. This heating of the rubber formulation may cause the statistical copolymer to form crosslinks within the rubber formulation.

In embodiments, an anionic initiator is used during polymerization of the statistical copolymer of the rubber formulation. In embodiments, the anionic initiator may be a hydrocarbyl lithium compound. In embodiments, the anionic initiator may comprise ethyl lithium, n-propyl lithium, isopropyl lithium, n-butyl lithium, sec-butyl lithium, tert-octyl lithium, n-decyl lithium, phenyl lithium, 2-naphthyl lithium, 2-butyl-phenyl lithium, 4-phenyl-butyl lithium, cyclohexyl lithium, cyclopentyl lithium, a reaction product of diisopropenylbenzene and butyl lithium, and combinations thereof. In embodiments, the anionic initiator may be n-butyl lithium.

In embodiments, a randomizing component may be used during the synthesis of the statistical copolymer of the rubber formulation. Without being bound by theory, it is believed that the randomizing component may influence the microstructure of the statistical copolymer allowing for a random distribution of monomer units of different compositions along the polymer chain.

In embodiments, the randomizing component may comprise those having an oxygen or nitrogen heteroatom and a non-bonded pair of electrons. Examples include linear and cyclic oligomeric oxolanyl alkanes; dialkyl ethers of mono and oligo alkylene glycols (also known as glyme ethers); “crown” ethers; tertiary amines; linear THF oligomers; and the like. Linear and cyclic oligomeric oxolanyl alkanes are described in U.S. Pat. Nos. 4,429,091 and 9,868,795, which is incorporated herein by reference. Specific examples of compounds useful as randomizers include 2,2-bis(2′-tetrahydrofuryl) propane, 1,2-dimethoxyethane, N,N,N′,N′-tetramethylethylenediamine (TMEDA), tetrahydrofuran (THF), 1,2-dipiperidylethane, dipiperidylmethane, hexamethylphosphoramide, N-N′-dimethylpiperazine, diazabicyclooctane, dimethyl ether, diethyl ether, tri-n-butylamine, and mixtures thereof. In other embodiments, potassium alkoxides can be used to randomize the styrene distribution.

In embodiments, the method of making the rubber formulation may comprise heating the rubber formulation to a temperature of from about 170° C. to about 240° C. In embodiments, the method may further comprise adding Cu(BF₄)₂ to the rubber formulation prior to heating. In embodiments the method of making the rubber formulation may comprise heating the rubber formulation to a temperature of greater than or equal to about 170° C., greater than or equal to about 180° C., greater than or equal to about 190° C., or even greater than or equal to about 200° C. In embodiments, the method of making the rubber formulation may comprise heating the rubber formulation to a temperature of less than or equal to about 240° C., less than or equal to about 230° C., less than or equal to about 220° C., or even less than or equal to about 210° C. In embodiments the method of making the rubber formulation may comprise heating the rubber formulation to a temperature of from about 170° C. to about 240° C., from about 170° C. to about 230° C., from about 170° C. to about 220° C., from about 170° C. to about 210° C., from about 180° C. to about 240° C., from about 180° C. to about 230° C., from about 180° C. to about 220° C., from about 180° C. to about 210° C., from about 190° C. to about 240° C., from about 190° C. to about 230° C., from about 190° C. to about 220° C., from about 190° C. to about 210° C., from about 200° C. to about 240° C., from about 200° C. to about 230° C., from about 200° C. to about 220° C., or even from about 200° C. to about 210° C., or any and all sub-ranged formed from these endpoints.

### Rubber Formulation

In embodiments, the rubber formulation may have a maximum torque MH of from about 19 dNm to about 30 dNm. In embodiments, the rubber formulation may have a minimum torque, ML of from about 0.7 to about 0.8 dNm. In embodiments, the rubber formulation may have a T 90 time of from about 50 minutes to about 70 minutes. In embodiments, the rubber formulation may have a T 50 time of from about 10 minutes to about 15 minutes.

The rubber formulations disclosed herein may have a similar loss tangent tan δ at 0° C., as compared to a control rubber formulation, which indicates similar wet traction performance. In embodiments, the rubber formulation may have a tan δ at 0° C. greater than or equal to 0.330.

A rubber composition's tan δ at 30° C. is indicative of its dry traction when incorporated into a tire tread. In embodiments, the rubber formulation may have a tan δ at 30° C. of greater than or equal to 0.130.

The rubber formulations disclosed herein have a decrease in the loss tangent tan δ at 60° C. as compared to a control rubber formulation, which correlates to reduced rolling resistance. In embodiments, the rubber formulation may have a tan δ at 60° C. less than or equal to 0.175.

The rubber formulations disclosed herein have a decrease in the storage modulus G′ at −20° C. or −30° C. as compared to a control rubber formulation, which correlates to increased snow or ice traction. In embodiments the rubber formulation may have a G′ at −20° C. less than or equal to 77. In embodiments the rubber formulation may have a G′ at −30° C. less than or equal to 1565.

In embodiments, the rubber formulation may have a change in storage modulus ΔG′ of from about 8.4 to about 7.8 as measured in strain sweep from 0.25% to 14% strain, run at 60° C. and 10 Hz.

In embodiments, the rubber formulation may have a change in loss tangent tan δ less from about 0.045 to about 0.060 as measured in strain sweep from 0.25% to 14% strain, run at 60° C. and 10 Hz.

In embodiments, the rubber formulation may have a loss tangent tan δ at 5% strain of from about 0.145 to about 0.155. In embodiments, the rubber formulation may have a loss tangent tan δ at 10% strain of from about 0.150 to about 0.170.

In embodiments, the rubber formulation may have a modulus at 200% strain M200 at room temperature from about 6.3 MPa to about 10.2 MPa. In embodiments, the rubber formulation may have a modulus at 200% strain M200 at 100° C. of from about 2.8 MPa to about 5.2 MPa. In embodiments, the rubber formulation may have a modulus at 100% strain M100 at room temperature of from about 11.1 MPa to about 15.4 MPa. In embodiments, the rubber formulation may have a modulus at 100% strain M100 at 100° C. of from about 5.0 MPa to about 6.6 MPa. In embodiments, the rubber formulation may have a modulus at 50% strain M50 at room temperature of from about 1.75 MPa to about 7.7 MPa. In embodiments, the rubber formulation may have a modulus at 50% strain M50 at 100° C. of from about 1.6 to about 6.6.

In embodiments, the rubber formulation may have a stress at break Tb at room temperature from about 10.5 MPa to 20 MPa. In embodiments, the rubber formulation may have a stress at break Tb at 100° C. from about 5 MPa to about 9 MPa. In embodiments, the rubber formulation may have an elongation at break Eb at room temperature from about 105% to about 320%. In embodiments, the rubber formulation may have an elongation at break Eb at 100° C. from about 55% to about 180%.

In embodiments, the rubber formulation may have a tensile strain % at tear of from about 55% to about 165%. In embodiments, the rubber formulation may have a toughness of from about 1000 MPa to about 3900 MPa. In embodiments, the rubber formulation may have a load per thickness of from about 11.5 N/m to about 20 N/m

In embodiments, the rubber formulations disclosed herein may have a bound rubber % similar to that of a control rubber formulation.

In embodiments, the rubber formulation may have a total swell % of from about 230% to about 300%.

In embodiments, the rubber formulation may be used in a tire tread. The rubber formulations of the present disclosure may also be utilized in other components and articles, which utilize rubber formulations, such as, for example, tire sidewalls, inner-tubes and tire inner liners, air cushions, pneumatic sprays, air bags, tire-curing bladders, high temperature hoses and conveyor belts, damping mounts for engines and the like.

In one or more embodiments, the tires and/or other rubber containing components and articles can include fabric reinforcement made by using non-petroleum materials in place of synthetic fibers. For example, mechanical recycled fibers, chemical recycled fibers, or bio-based fibers can be used. Likewise, the tires can include metal reinforcement made from recycled steel and/or other circular or sustainable metals. These non-petroleum fabrics and recycled metals can be used exclusively within the tires or in combination with traditional fabric and/or metal reinforcement.

### EXAMPLES

The rubber formulations described herein will be further described in the following examples, which are not intended to restrict the rubber formulations.

### Measurements

The number average molecular weight (Mn), weight average molecular weight (Mw), and the peak molecular weight (Mp) were determined by gel permeation chromatography using a TOSOH Esosec HLC-8320 GPC system and TOSOH TSKgel GMHxl-BS columns with THE as the solvent. The system was calibrated using universal calibration with polystyrene standards and corrected using the Mark-Houwink constants for polybutadiene or poly(styrene-co-butadiene).

The vinylbenzocyclobutane content, vinyl content, and styrene content were determined by 1H-Nuclear Magnetic Resonance spectroscopy in d-chloroform at 25° C.

“Glass transition temperature T_{g}” was measured by differential scanning calorimetry. The differential scanning calorimetry method included a starting temperature of 23° C., heating to 200° C. at a 10° C./min ramp rate, cooling to −120° C., and reheating to 200° C. at a 10° C./min ramp rate.

Tan δ at 0° C., 30° C., and 60° C. and G′ at −20° C. were measured using a temperature sweep test conducted with an Advanced Rheometric Expansion System (ARES) from TA Instruments. The Test was conducted using a frequency of 3.14 rad/sec. The temperature was started at −115° C. and increased to 100° C.

The tensile mechanical properties modulus at 50% strain, modulus at 200% strain, stress at break Eb, and maximum strain Tb were determined following the guidelines, but not restricted to, the standard procedure described in ASTM D412, using dumbbell specimens. Specimens were strained at a constant rate and the resulting force was recorded as a function of extension (strain). Force readings were expressed as engineering stresses by reference to the original cross-sectional area of the test piece. The specimens were tested at 28° C. The same tensile mechanical properties were also tested at 100° C. Maximum stress and maximum strain percentage were also measured at both temperatures.

### Example 1—Synthesis of Vinylbenzocyclobutane Copolymers

To an oven dried, nitrogen-purged 800 ml bottle, 119.8 g of hexanes, 35.3 g of a 34 wt. % solution of styrene in hexanes, 244.9 g of a 19.6 wt. % solution of 1,3-butadiene in hexanes, 0.09 mL of a 1.6 M solution of 2,2-ditetrahydrofurylpropane (80% meso isomer) in hexanes, and 0.25 mL of a 1.6 M solution of n-butyl lithium in hexanes were added. To produce Polymers 1-3, varying amounts of a 1 M solution of 4-vinylbenzocyclobutane (VBCB) in hexanes were also added. The amount of 4-vinylbenzocyclobutane for each reaction to produce Comparative Polymers A and B and Polymers 1-3 is shown in Table 1. After addition, the bottle was immersed in a 50° C. water bath and agitated. After 2 hours, the polymer solution was removed from the water bath and terminated with 0.1 mL of isopropanol. The solution was coagulated in an excess of isopropanol containing butylated hydroxytoluene. The properties of the produced polymers are shown in Table 2

TABLE 1
Amount of 4-Vinylbenzocyclobutane Added

| | Comparative | Comparative | Polymer | Polymer | Polymer |
|---|---|---|---|---|---|
| | Polymer A | Polymer B | 1 | 2 | 3 |
| VBCB | 0 | 0 | 2 | 4 | 6 |
| 1(M), mL | | | | | |

TABLE 2
Properties of Synthesized Polymers

| | Comparative | Comparative | | | |
|---|---|---|---|---|---|
| Property | Polymer A | Polymer B | Polymer 1 | Polymer 2 | Polymer 3 |
| Mₚ (kg/mol) | 143.4 | 139.3 | 134.3 | 140.3 | 142.4 |
| Mₙ (kg/mol) | 141.2 | 137.2 | 131.2 | 137.4 | 138.8 |
| M_{w} (kg/mol) | 149.3 | 144.7 | 138.0 | 145.2 | 146.0 |
| Polydispersity | 1.06 | 1.06 | 1.05 | 1.06 | 1.05 |
| (PDI) | | | | | |
| T_{g} (° C.) | −29.2 | −31.5 | −30.6 | −29.6 | −31.8 |
| wt. % Styrene | 20.9 | 21.0 | 20.6 | 20.8 | 20.9 |
| wt. % Vinyl | 60.9 | 59.2 | 59.0 | 60.1 | 58.5 |
| VBCB units per | 0 | 0 | 4.4 | 9.1 | 11.6 |
| chain | | | | | |

### Example 2—Compounding Polymers with Carbon Black

In Example 2, the polymers synthesized in Example 1, were compounded to form rubber formulations. The formulations of the compound mixtures are shown in Tables 3 and 4 (in phr). Each rubber formulation was prepared first in a master batch and then a final batch. In the master batch, the comparative polymers from Table 2 were mixed with carbon black, zinc oxide, stearic acid, and oil, while Polymer 1, Polymer 2, and Polymer 3 were mixed with carbon black and oil.

The master batch portion of the compound was mixed in a 65 g Banbury mixer operating with cam rotors at 60 RPM and 133° C. First, polymer was placed in the mixer, and after 30 seconds, the remaining ingredients, except stearic acid, were added. For the comparative samples, the stearic acid was then added after 3 minutes. The master batches were mixed for a total of 5 to 6 minutes. At the end of mixing, the temperatures of the polymer were approximately 165° C. The master batch portions were then transferred to a mill operating at a temperature of 60° C., where they were sheeted and subsequently cooled to room temperature.

The final batch portions were mixed by adding the master batch and the curative materials to the mixer simultaneously for the comparative samples, but for the experimental samples, only the master batch was added to the mixer. The initial mixer temperature was 65° C. and it was operated at 45 RPM. The final material was removed from the mixer after 2.5 minutes when the material temperature was between 100° C. and 105° C. The final batch portions were then sheeted into Dynastat buttons and 7.62 cm×15.24 cm×0.19 cm sheets. The comparative formulations, C1 and C2, were cured at 171° C. for 30 minutes in standard molds placed in a hot press. The example formulations E1, E2, and E3 were cured at 220° C. for forty-five minutes.

TABLE 3
Master Batch Formulation

| Property | C1 | C2 | E1 | E2 | E3 |
|---|---|---|---|---|---|
| Comparative | 100 | 0 | 0 | 0 | 0 |
| Polymer A | | | | | |
| Comparative | 0 | 100 | 0 | 0 | 0 |
| Polymer B | | | | | |
| Polymer 1 | 0 | 0 | 100 | 0 | 0 |
| Polymer 2 | 0 | 0 | 0 | 100 | 0 |
| Polymer 3 | 0 | 0 | 0 | 0 | 100 |
| Heavy | 15 | 15 | 15 | 15 | 15 |
| Napthenic | | | | | |
| Oil | | | | | |
| Stearic Acid | 2 | 1.8 | 0 | 0 | 0 |
| Zinc Oxide | 5 | 4.5 | 0 | 0 | 0 |
| Carbon Black | 50 | 50 | 50 | 50 | 50 |
| (N336) | | | | | |
| Total | 172 | 171.3 | 165 | 165 | 165 |

TABLE 4
Final Batch Formulation

| Property | C1 | C2 | E1 | E2 | E3 |
|---|---|---|---|---|---|
| Master Batch | 172 | 171.3 | 165 | 165 | 165 |
| Accelerator | 1 | 0.9 | 0 | 0 | 0 |
| Sulfur | 1.75 | 1.575 | 0 | 0 | 0 |
| Total | 174.75 | 173.775 | 165 | 165 | 165 |

Referring now to Table 5, the Rubber Process Analyzer (RPA) results at 171° C. for the comparative formulations and at 220° C. for the example formulations are shown as measured according to ASTM D5289.

TABLE 5
Curing Characteristics

| | | | | | |
|---|---|---|---|---|---|
| Property | C1 | C2 | E1 | E2 | E3 |

RPA 171° C.

| | | | | | |
|---|---|---|---|---|---|
| MH, dNm | 19.1 | 17.35 | — | — | — |
| ML, dNm | 0.9 | 0.9 | — | — | — |
| T 90, min | 17.49 | 20.02 | — | — | — |
| T 50, min | 7.78 | 8.74 | — | — | — |

RPA 220° C.

| | | | | | |
|---|---|---|---|---|---|
| MH, dNm | — | — | 19.69 | 26.57 | 29.73 |
| ML, dNm | — | — | 0.75 | 0.79 | 0.75 |
| T 90, min | — | — | 65.89 | 55.52 | 52.85 |
| T 50, min | — | — | 14.77 | 10.83 | 10.16 |

As shown in Table 5, example formulations E1, E2, and E3 cured without the use of accelerators or sulfur to similar or higher crosslink densities than the comparative formulations C1 and C2 as shown by the similar or higher MH values of E1, E2, and E3.

Referring now to Table 6, certain tensile properties are shown.

TABLE 6
Tensile Properties

| | | | | | |
|---|---|---|---|---|---|
| Property | C1 | C2 | E1 | E2 | E3 |

Tensile at 28° C.

| | | | | | |
|---|---|---|---|---|---|
| 200% Modulus, MPa | 6.51 | 5.57 | 6.32 | 10.19 | — |
| 50% Modulus, MPa | 1.77 | 1.63 | 1.80 | 2.4 | 2.69 |
| Eb, Percent | 388 | 489 | 318 | 236 | 182 |
| Tb, MPa | 15.1 | 17.3 | 11.4 | 12.7 | 10.9 |

Tensile at 100° C.

| | | | | | |
|---|---|---|---|---|---|
| 200% Modulus, MPa | 2.69 | 2.29 | 2.88 | 4.24 | 5.16 |
| 50% Modulus, MPa | 1.51 | 1.35 | 1.64 | 2.26 | 2.62 |
| Eb, Percent | 216 | 281 | 176 | 126 | 103 |
| Tb, MPa | 6.2 | 6.9 | 5.2 | 5.5 | 5.3 |

As shown in Table 6, the example formulations E2 and E3 have a larger modulus at both 200% and 50% as well as a lower elongation break percent at both 28° C. and 100° C. Larger moduli and lower elongation at break indicate that E2 and E3 had a higher density of crosslinks than the comparative formulations C1 and C2, which is consistent with the data from the RPA test in Table 5. Taken together, Table 5 and Table 6 show that the properties of the cured rubber formulations may be controlled by controlling the amount of VBCB in the polymer.

Now referring to Table 7, the bound rubber content and swell of the rubber formulations are shown. The bound rubber content test was used to determine the percent of polymer bound to filler particles in each rubber composition. Bound rubber was measured by immersing small pieces of uncured stocks in a large excess of toluene for three days. The soluble rubber was extracted from the sample by the solvent. After three days, any excess toluene was drained off and the sample was air dried and then dried in an oven at approximately 100° C. to a constant weight. The remaining pieces form a weak coherent gel containing the filler and some of the original rubber. The amount of rubber remaining with the filler is the bound rubber. The bound rubber content is then calculated according to the following:

$$\% Bound Rubber = \frac{100 ( Wd - F )}{R}$$

where Wd is the weight of dried gel, F is the weight of filler in gel or solvent insoluble matter (same as weight of filler in original sample), and R is the weight of polymer in the original sample. The bound rubber percentage provides a means of measuring the interaction between the rubber (polymer) within a rubber composition and the filler, with relatively higher percentages of bound rubber indicating increased and beneficial interaction between the rubber (polymer) and filler. Swell was measured according to ASTM D2765.

TABLE 7
Bound Rubber Content and Swell

| | C1 | C2 | E1 | E2 | E3 |
|---|---|---|---|---|---|
| Bound Rubber, % | 10 | 10 | 10 | 11 | 9 |
| Total Swell, % | 279 | 310 | 300 | 243 | 230 |

As shown in Table 7, the comparative and example formulations showed a similar percentage, +5%, of bound rubber, indicating the presence of VBCB did not interfere with the rubber-filler interactions in the rubber formulations. The example formulations E2 and E3 had a lower swell percentage than the comparative formulations C1 and C2 indicating that E2 and E3 had a higher crosslink density than C1 or C2.

### Example 3—Compounding Polymers with Silica

In Example 3, 6 polymers were synthesized using the same procedure as the synthesis of Example 1, except for polymer 5 where 2.4 mL of 1M 4-vinylbenzocyclobutane (VBCB) in hexanes was added after the butadiene addition. After two hours of polymerization, an additional 0.4 mL of 1M 4-vinylbenzocyclobutane (VBCB) in hexanes was added and the bottle returned to the bottle bath at 50 C for 30 minutes. The solution was then terminated with 0.1 ml of isopropanol. The solution was coagulated in an excess of isopropanol containing butylated hydroxytoluene. The properties of the polymers were recorded in Table 8. The polymers were then compounded into rubber formulations. The formulations of the compound mixtures are shown in Tables 9, 10, 10a and 11 (in phr). Each rubber formulation was prepared first in a master batch and then a final batch.

TABLE 8
Synthesized Polymer Composition

| | Comparative | Polymer | Polymer | Polymer | Polymer | Polymer |
|---|---|---|---|---|---|---|
| Property | Polymer C | 4 | 5 | 6 | 7 | 8 |
| VBCB per chain | 0 | 5.8 | 5.7 | 4.9 | 6.3 | 10.3 |
| % Styrene | 21.2 | 20.9 | 20.9 | — | — | — |
| % Vinyl | 65.8 | 64.3 | 65.3 | — | — | — |
| Mp (kg/mol) | 154.1 | 147.5 | 144.3 | 163.4 | 157.5 | 171.9 |
| Mn (kg/mol) | 150.7 | 143.8 | 140.0 | 157.8 | 153.2 | 167.3 |
| Mw (kg/mol) | 164.0 | 151.4 | 149.8 | 168.0 | 162.0 | 178.0 |
| PDI | 1.09 | 1.05 | 1.07 | 1.06 | 1.06 | 1.06 |
| Tg, ° C. | −26.0 | −27.3 | −25.1 | −25.4 | −27.3 | −26.8 |

The master batch portion of the compound was mixed in a 65 g Banbury mixer operating with cam rotors at 60 RPM and 133° C. First, polymer was placed in the mixer, and after 30 seconds, the remaining ingredients, except stearic acid, were added. The master batches were mixed for a total of 5 to 6 minutes. At the end of mixing, the temperatures of the rubber samples were approximately 165° C. The master batch portions were then transferred to a mill operating at a temperature of 60° C., where they were sheeted and subsequently cooled to room temperature.

The first remill portions were mixed by adding the master batch and additional silica, silane, resin, and AO. For the comparative samples, the stearic acid was then added after 3 minutes. The remills were mixed for a total of 4 to 5 minutes. At the end of mixing, the temperatures of the rubber samples were approximately 165° C. The remill portions were then transferred to a mill operating at a temperature of 60° C., where they were sheeted and subsequently cooled to room temperature.

The second remill portions were mixed by adding the first remill to the 65 g Brabender mixer operating with cam rotors at 45 RPM and 133° C. The second remill portions were mixed for a total of 4 to 5 minutes. At the end of mixing, the temperatures of the rubber samples were approximately 165° C. The second remill portions were then transferred to a mill operating at a temperature of 60° C., where they were sheeted and subsequently cooled to room temperature.

The final batch portions were mixed by adding the second remill portions and the curative materials to the mixer simultaneously for the comparative samples, but for the experimental samples, only the second remill was added to the mixer. The initial mixer temperature was 65° C. and it was operated at 45 RPM. The final material was removed from the mixer after 2.5 minutes when the material temperature was between 100° C. and 105° C. The final batch portions were then sheeted into Dynastat buttons and 7.62 cm×15.24 cm×0.19 cm sheets. The comparative formulation, C3, was cured at 171° C. for 30 minutes in standard molds placed in a hot press. The example formulations E4, E5, E6, E7 and E8 were cured at 220° C. for forty-five minutes.

TABLE 9
Silica Master Batch

| Component | C3 | E4 | E5 | E6 | E7 | E8 |
|---|---|---|---|---|---|---|
| Comparative | 100 | 0 | 0 | 0 | 0 | 0 |
| Polymer C | | | | | | |
| Polymer 4 | 0 | 100 | 0 | 0 | 0 | 0 |
| Polymer 5 | 0 | 0 | 100 | 0 | 0 | 0 |
| Polymer 6 | 0 | 0 | 0 | 100 | 0 | 0 |
| Polymer 7 | 0 | 0 | 0 | 0 | 100 | 0 |
| Polymer 8 | 0 | 0 | 0 | 0 | 0 | 100 |
| Carbon | 7 | 7 | 7 | 7 | 7 | 7 |
| Black | | | | | | |
| Silica | 55 | 55 | 55 | 55 | 55 | 55 |
| Silane | 5.5 | 5.5 | 5.5 | 5.5 | 5.5 | 5.5 |
| Plasticizer | 20 | 20 | 20 | 20 | 20 | 20 |
| Processing | 1 | 1 | 1 | 1 | 1 | 1 |
| aid | | | | | | |
| Wax | 2 | 2 | 2 | 2 | 2 | 2 |

TABLE 10
First Remill

| | C3 | E4 | E5 | E6 | E7 | E8 |
|---|---|---|---|---|---|---|
| Master | 190.5 | 190.5 | 190.5 | 190.5 | 190.5 | 190.5 |
| Batch | | | | | | |
| Silica | 36 | 36 | 36 | 36 | 36 | 36 |
| Silane | 3.6 | 3.6 | 3.6 | 3.6 | 3.6 | 3.6 |
| Plasticizer | 12 | 12 | 12 | 12 | 12 | 12 |
| Stearic | 2 | 0 | 0 | 0 | 0 | 0 |
| Acid | | | | | | |
| AO | 1.37 | 1.37 | 1.37 | 1.37 | 1.37 | 1.37 |

TABLE 10a
Second Remill

| | C3 | E4 | E5 | E6 | E7 | E8 |
|---|---|---|---|---|---|---|
| Remill | 245.47 | 243.47 | 243.47 | 243.47 | 243.47 | 243.47 |

TABLE 11
Final Batch Formulation

| | C3 | E4 | E5 | E6 | E7 | E8 |
|---|---|---|---|---|---|---|
| Master Batch | 245.47 | 243.47 | 243.47 | 243.47 | 243.47 | 243.47 |
| Sulfur | 1.5 | 0 | 0 | 0 | 0 | 0 |
| Accelerators | 6.27 | 0 | 0 | 0 | 0 | 0 |
| ZnO | 2.5 | 0 | 0 | 0 | 0 | 0 |

Referring now to Table 12, certain tensile properties of the rubber formulations are shown.

TABLE 12
Tensile Properties

| | | | | | | |
|---|---|---|---|---|---|---|
| Property | C3 | E4 | E5 | E6 | E7 | E8 |

Tensile at 28° C.

| | | | | | | |
|---|---|---|---|---|---|---|
| 100% Modulus, | 8.89 | 14.31 | 11.14 | 12.75 | 13.88 | 15.37 |
| MPa | | | | | | |
| 50% Modulus, | 4.79 | 7.64 | 5.98 | 6.75 | 7.02 | 7.62 |
| MPa | | | | | | |
| Eb, Percent | 182 | 114 | 165 | 138 | 120 | 106 |
| Tb, MPa | 16.8 | 16.2 | 19 | 17.7 | 16.8 | 16.2 |

Tensile at 100° C.

| | | | | | | |
|---|---|---|---|---|---|---|
| 100% Modulus, | 6.7 | 0 | 9.32 | 0 | 0 | 0 |
| MPa | | | | | | |
| 50% Modulus, | 3.45 | 5.74 | 5.03 | 5.45 | 5.64 | 6.52 |
| MPa | | | | | | |
| Eb, Percent | 103 | 56 | 91 | 71 | 73 | 60 |
| Tb, MPa | 6.9 | 8.6 | 8.6 | 7.4 | 7.9 | 7.7 |

As shown in Table 12, the example formulations E4-E8 had a larger modulus at both 100% and 50% as well as a lower elongation break percent. Larger moduli and lower elongation at break indicate that E4-E8 had a higher density of crosslinks than the comparative formulation C3. Further, example formulation E5, which has VBCB monomer units located at the end of the polymer chain has an increased elongation break percent when compared to the other example formulations which is closed to that of the comparative formulation C3.

### Example 4—Use of Catalysts to Accelerate Cure

In Example 4, the effect of catalysts on the curing of polymers including VBCB monomer was examined. A polymer was synthesized according to the procedure of Example 1 and the properties of the synthesized polymer, Polymer 9, are shown in Table 13. 0.78 phr of Cu(BF₄)₂ was added to one portion of the polymer and the polymer, without catalyst and with catalyst, was then cured at 200° C. to examine the effect of this addition on the curing of the polymer. The test was run on an RPA from Alpha Technologies at 0.1% strain and 10 Hz.

TABLE 13
Polymer 9

| Property | Polymer 9 |
|---|---|
| VBCB per chain | 8.6 |
| % Styrene | 27.1 |
| % Vinyl | 59.7 |
| Mp (kg/mol) | 151.3 |
| Mn (kg/mol) | 143.1 |
| Mw (kg/mol) | 151.7 |
| PDI | 1.06 |
| Tg, ° C. | −29.5 |
| Weight between | 17.6 |
| VBCB (kg/mol) | |

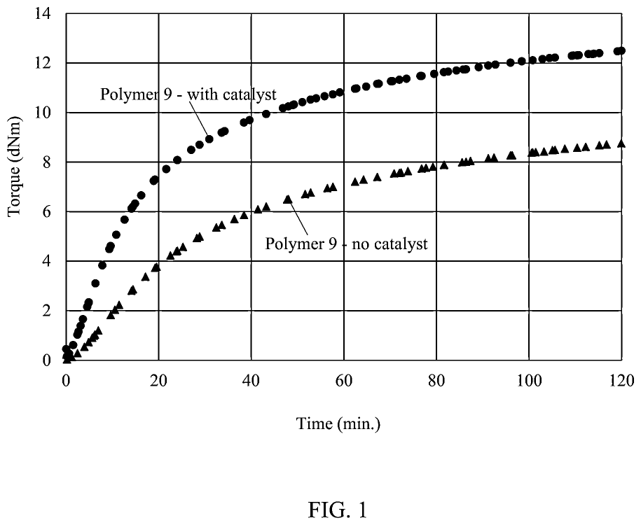

As shown in FIG. 1, the addition of Cu(BF₄)₂ to the polymer resulted in a faster and stronger cure at 200° C. when compared to a polymer that did not have Cu(BF₄)₂ added, indicating that the presence of Cu(BF₄)₂ effectively catalyzes the curing of a polymer that contains VBCB.

Embodiments of the invention include but are not limited to:

1. A rubber formulation comprising: a statistical copolymer, the statistical copolymer comprising a polymerized, crosslinkable reaction product derived from a conjugated diene monomer and vinylbenzocyclobutane; and wherein the rubber formulation is substantially free of traditional rubber curatives.

2. The rubber formulation of any preceding clause, wherein the traditional rubber curatives comprise: sulfur and peroxide.

3. The rubber formulation of any preceding clause, wherein the curatives comprise zinc oxide, sulfur, diphenylguanidine, fatty acids, benzothiazoles, sulfenamides, sulfenimides, thiurams, dithiocarbamates, or combinations thereof.

4. The rubber formulation of any preceding clause, wherein a rubber component of the rubber formulation comprises from about 20 phr to about 100 phr of the statistical copolymer, based on the total weight of the rubber component.

5. The rubber formulation of any preceding clause, wherein the conjugated diene monomer is selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, 1,3-cyclooctadiene, and combinations thereof.

6. The rubber formulation of any preceding clause, wherein the statistical copolymer comprises a polymerized, crosslinkable, reaction product derived from the conjugated diene monomer, the vinylbenzocyclobutane, and a vinyl aromatic monomer.

7. The rubber formulation of any preceding clause, wherein the vinyl aromatic monomer is selected from the group consisting of styrene, alpha-methyl styrene, p-methylstyrene, o-methylstyrene, p-butyl styrene, vinylnapthalene, p-tertbutylstyrene, 4-vinylbiphenyl, 2-vinylnapthalene, 9-vinylanthracene, vinyl catechol, and combinations thereof.

8. The rubber formulation of any preceding clause, wherein the conjugated diene monomer is 1,3-butadiene and the vinyl aromatic monomer is styrene.

9. The rubber formulation of any preceding clause, wherein the rubber formulation further comprises from about 5 to about 75 phr of carbon black.

10. The rubber formulation of any preceding clause, wherein the rubber formulation further comprises from about 1 phr to about 70 phr of oil.

11. The rubber formulation of any preceding clause, wherein the rubber formulation further comprises from about 1 phr to about 150 phr of silica.

12. The rubber formulation of any preceding clause, wherein the rubber formulation further comprises from about 1 phr to about 20 phr of silane.

13. The rubber formulation of any preceding clause, wherein the rubber formulation further comprises CuOCOCH₃, Cu(OCOCH₃)₂, Cu(OCOCH₃)₂xH₂O, Cu(C₅H₇O₂)₂, CuBr, CuBr₂, CuCO₃, CuCO₃, Cu(OH)₂, CuCl, CuCl₂, CuCl₂xH₂O, Cu [CH₃ (CH₂)₃CH(C₂H₅) CO₂]₂, CuF₂, CuF₂xH₂O, Cu(HCO₂)₂, Cu(HCO₂)₂xH₂O, Cu(OH)₂, Cu₂ (OH) PO₄, CuI, CuFe₂O₄, Cu(NO₃)₂, Cu(NO₃)₂xH₂O, Cu₂O, CuO, Cu(C₃₂H₁₆N₈), Cu₂P₂O₇xH₂O, CuSO₄, CuSO₄xH₂O, CuS, Cu [O₂CCH(OH) CH(OH) CO₂]xH₂O, Cu(BF₄)₂, Cu(BF₄) xH₂O, Cu(SCN), Cu(BF₄)₂, Cu(PF₆)₂, CuF₂ or combinations thereof.

14. The rubber formulation of any preceding clause, wherein the rubber formulation further comprises Cu(BF₄)₂, Cu(PF₆)₂, CuF₂, or combinations thereof.

15. The rubber formulation of any preceding clause, wherein the rubber formulation further comprises a styrene-butadiene rubber, a butadiene rubber, butyl rubber, EPDM, natural rubber, polyisoprene, or combinations thereof, and wherein the styrene-butadiene rubber and the butadiene rubber do not comprise a polymerized reaction product derived from vinylbenzocyclobutane.

16. The rubber formulation of any preceding clause, wherein the rubber formulation is cured by heating the rubber formulation to a temperature of greater than or equal to 200° C.

17. The rubber formulation of any preceding clause, wherein the statistical copolymer has a weight average molecular weight of greater than or equal to about 1.0×10⁵ g/mol.

18. The rubber formulation of any preceding clause, wherein the statistical copolymer comprises from about 0.02 wt. % to about 2 wt. % of the vinylbenzocyclobutane, based on the total weight of the statistical copolymer.

19. The rubber formulation of any preceding clause, wherein the statistical copolymer comprises from 1 to 15 vinylbenzocyclobutane monomer units per chain of the statistical copolymer.

20. The rubber formulation of any preceding clause, wherein the statistical copolymer comprises from about 50 wt. % to about 99 wt. % of the conjugated diene monomer, based on the total weight of the statistical copolymer.

21. The rubber formulation of any preceding clause, wherein the statistical copolymer comprises from about 5 wt. % to about 50 wt. % of the vinyl aromatic monomer, based on the total weight of the statistical copolymer.

22. The rubber formulation of any preceding clause, wherein the statistical copolymer has at least 1 vinylbenzocyclobutane monomer unit at an end of a polymer chain.

23. A tire tread comprising the rubber formulation of any preceding clause.

24. A method of making the rubber formulation of any preceding clause, the method comprising: heating the rubber formulation to a temperature of from about 170° C. to about 240° C., wherein heating the rubber formulation causes the statistical copolymer to form crosslinks within the rubber formulation.

25. The method of any preceding clause, further comprising adding one or more compounds comprising Cu(BF₄)₂, Cu(PF₆)₂, CuF₂ to the rubber formulation prior to heating.

26. The method of any preceding clause, wherein the anionic initiator comprises ethyl lithium, n-propyl lithium, isopropyl lithium, n-butyl lithium, sec-butyl lithium, tert-octyl lithium, n-decyl lithium, phenyl lithium, 2-naphthyl lithium, 2-butyl-phenyl lithium, 4-phenyl-butyl lithium, cyclohexyl lithium, cyclopentyl lithium, a reaction product of diisopropenylbenzene and butyl lithium, and combinations thereof.

27. The method of any preceding clause, wherein the anionic initiator is n-butyl lithium.

28. The method of any preceding clause, wherein the randomizing component comprises 2,2-ditetrahydrofurylpropane, meso-2,2-ditetrahydrofurylpropane, dimethoxybenzene, tetrahydrofuran, dimethoxyethane, diethylene glycol dibutyl ether, diethylene glycol dimethyl ether, triethylamine, pyridine, N-methylmorpholine, N,N,N′,N′-tetramethyl ethylenediamine, 1,2-dipiperidinoethane, potassium-t-amylate, potassium-t-butoxide, sodium-t-amylate, or combinations thereof.

29. A tire component comprising: a cured rubber matrix with filler dispersed therein, where the cured rubber matrix includes greater than 40 wt. %, or 50 wt. %, or 60 wt. %, or 70 wt. %, or 80 wt. %, or 90 wt. %, or 99 wt. % of a statistical copolymer, the statistical copolymer comprising a polymerized, crosslinkable reaction product derived from a conjugated diene monomer and vinylbenzocyclobutane; and one or more additional constituents dispersed within the cured rubber matrix and one or more of these additional constituents are sustainable materials.

30. The tire component of any preceding clause, wherein the additional sustainable materials includes recycled carbon black.

31. The tire component of any preceding clause, wherein the additional sustainable materials include rice husk ash derived silica, and a pyrolysis carbon black.

32. The tire component of any preceding clause, where the tire component includes a sustainable oil dispersed within said rubber matrix.

33. A tire including the tire component of any preceding clause, where the tire component is included within a tire, and where the tire includes greater than 40 wt. %, or 50 wt. %, or 60 wt. %, or 70 wt. %, or 80 wt. %, or 90 wt. %, or 99 wt. % sustainable material.

34. The tire of any preceding clause, where the tire includes recycled metal.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects:

1. A rubber formulation comprising:
a statistical copolymer, the statistical copolymer comprising a polymerized, crosslinkable reaction product derived from a conjugated diene monomer and vinylbenzocyclobutane; and
wherein the rubber formulation is substantially free of traditional rubber curatives.

2. The rubber formulation of claim 1, wherein the traditional rubber curatives comprise:
sulfur and peroxide.

3. The rubber formulation of claim 1, wherein the curatives comprise zinc oxide, sulfur, diphenylguanidine, fatty acids, benzothiazoles, sulfenamides, sulfenimides, thiurams, dithiocarbamates, or combinations thereof.

4. The rubber formulation of claim 1, wherein a rubber component of the rubber formulation comprises from about 20 phr to about 100 phr of the statistical copolymer, based on the total weight of the rubber component.

5. The rubber formulation of claim 1, wherein the conjugated diene monomer is selected from the group consisting of 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene, 2,4-hexadiene, 1,3-cyclopentadiene, 1,3-cyclohexadiene, 1,3-cycloheptadiene, 1,3-cyclooctadiene, and combinations thereof.

6. The rubber formulation of claim 1, wherein the statistical copolymer comprises a polymerized, crosslinkable, reaction product derived from the conjugated diene monomer, the vinylbenzocyclobutane, and a vinyl aromatic monomer, the vinyl aromatic monomer being selected from the group consisting of styrene, alpha-methyl styrene, p-methylstyrene, o-methylstyrene, p-butyl styrene, vinylnapthalene, p-tertbutylstyrene, 4-vinylbiphenyl, 2-vinylnapthalene, 9-vinylanthracene, vinyl catechol, and combinations thereof.

7. The rubber formulation of claim 1, wherein the rubber formulation further comprises:
from about 5 to about 75 phr of carbon black;
from about 1 phr to about 70 phr of oil;
from about 1 phr to about 150 phr of silica; and
from about 1 phr to about 20 phr of silane.

8. The rubber formulation of claim 1, wherein the rubber formulation further comprises Cu(BF₄)₂, Cu(PF₆)₂, CuF₂, or combinations thereof.

9. The rubber formulation of claim 1, wherein the rubber formulation further comprises a styrene-butadiene rubber, a butadiene rubber, butyl rubber, EPDM, natural rubber, polyisoprene, or combinations thereof, and wherein the styrene-butadiene rubber and the butadiene rubber do not comprise a polymerized reaction product derived from vinylbenzocyclobutane.

10. The rubber formulation of claim 1, wherein the rubber formulation is cured by heating the rubber formulation to a temperature of greater than or equal to 200° C.

11. The rubber formulation of claim 1, wherein the statistical copolymer has a weight average molecular weight of greater than or equal to about 1.0×10⁵ g/mol.

12. The rubber formulation of claim 1, wherein the statistical copolymer comprises from about 0.02 wt. % to about 2 wt. % of the vinylbenzocyclobutane, based on the total weight of the statistical copolymer.

13. The rubber formulation of claim 1, wherein the statistical copolymer comprises from 1 to 15 vinylbenzocyclobutane monomer units per chain of the statistical copolymer.

14. The rubber formulation of claim 1, wherein the statistical copolymer comprises from about 50 wt. % to about 99 wt. % of the conjugated diene monomer, based on the total weight of the statistical copolymer.

15. The rubber formulation of claim 6, wherein the statistical copolymer comprises from about 5 wt. % to about 50 wt. % of the vinyl aromatic monomer, based on the total weight of the statistical copolymer.

16. The rubber formulation of claim 1, wherein the statistical copolymer has at least 1 vinylbenzocyclobutane monomer unit at an end of a polymer chain.

17. A tire tread comprising the rubber formulation of claim 1.

18. A method of making the rubber formulation of claim 1, the method comprising:
heating the rubber formulation to a temperature of from about 170° C. to about 240° C.,
wherein heating the rubber formulation causes the statistical copolymer to form crosslinks within the rubber formulation.

19. The method of claim 18, further comprising adding one or more compounds comprising Cu(BF₄)₂, Cu(PF₆)₂, CuF₂ to the rubber formulation prior to heating.

20. A tire component comprising:
a cured rubber matrix with filler dispersed therein, where the cured rubber matrix includes greater than 40 wt. %, or 50 wt. %, or 60 wt. %, or 70 wt. %, or 80 wt. %, or 90 wt. %, or 99 wt. % of a statistical copolymer, the statistical copolymer comprising a polymerized, crosslinkable reaction product derived from a conjugated diene monomer and vinylbenzocyclobutane; and one or more additional constituents dispersed within the cured rubber matrix and one or more of these additional constituents are sustainable materials.
